(19) United States
(12) Patent Application Publication
(10) Pub. No.: US 2023/0041202 A1
(43) Pub. Date: Feb. 9, 2023

(54) ELECTRONIC CIRCUIT INTEGRATION TO SMART GLASSES FOR ENHANCED REALITY APPLICATIONS

(71) Applicant: Meta Platforms Technologies, LLC, Menlo Park, CA (US)

(72) Inventors: Igor Markovsky, Campbell, CA (US); Johana Gabriela Coyoc Escudero, Union City, CA (US); Demetrios Basil Karanikos, San Francisco, CA (US); Brandon Potens, San Jose, CA (US); Rafat Mehdi, San Mateo, CA (US); Sebastian Sztuk, Virum (DK); Pablo Castillo Canales, San Ramon, CA (US); Eric Daniels, San Francisco, CA (US); Andriy Pletenetskyy, Los Angeles, CA (US); Abhinav Subramani, Santa Clara, CA (US); Jaykishan Dakshesh Choksi, Santa Clara, CA (US); Katherine Suzi Torigoe, San Francisco, CA (US); Raymond Lee, Palo Alto, CA (US); Evan Lawrence Coons, Pleasanton, CA (US); Yi-Chen Kuo, Santa Clara, CA (US); Kai Tashima McKenney, San Jose, CA (US); Simon David-Levinskas Hodgson, Morgan Hill, CA (US); Trevor Grant Boswell, Madera, CA (US); Punit Narendra Govenji, Pleasanton, CA (US); Nan Wang, Sunnyvale, CA (US); Melinda Dora Szabo, Stanford, CA (US); Yewching Chen, San Jose, CA (US); Afsoon Jamali, Issaquah, WA (US)

(21) Appl. No.: 17/863,266

(22) Filed: Jul. 12, 2022

Related U.S. Application Data
(60) Provisional application No. 63/229,034, filed on Aug. 3, 2021.
(60) Provisional application No. 63/278,350, filed on Nov. 11, 2021.

(51) Int. Cl. G02B 27/01

(52) U.S. Cl. CPC G02B 27/0176; G02B 2027/0169; G02B 2027/0178; G02B 2027/0161

(57) ABSTRACT

A device including a frame and an eyepiece is provided. The eyepiece includes a front glass, a rear glass, and an active element sandwiched between the front glass and the rear glass. The active layer is electrically activated, via an interconnect, by a flex circuit enclosed between a top portion of the frame and a cap, the flex circuit including a memory and a processor. A method for assembling the above device is also provided.

### CROSS-REFERENCE TO RELATED APPLICATIONS

The present disclosure is related and claims priority under 35 U.S.C. § 119(e) to U.S. Prov. Appln. No. 63/229,034, entitled SMART GLASS INTERCONNECT FOR ENHANCED REALITY APPLICATIONS, filed on Aug. 3, 2021, to Johana ESCUDERO, et al., and to U.S. Prov. Appln. No. 63/278,350, entitled ELECTRONIC CIRCUIT INTEGRATION TO SMART GLASSES FOR ENHANCED REALITY APPLICATIONS, filed on Nov. 11, 2021, to Igor MARKOVSKY, et al., the contents of which are hereby incorporated by reference in their entirety, for all purposes.

### BACKGROUND

### Field

The present disclosure is related generally to a user interface for headsets and wearable devices. More specifically, the present disclosure is related to assembly and integration of electronic circuits in smart glasses for enhanced reality applications.

### Related Art

Wearable devices have simple user interfaces so that users can easily provide commands and adjust settings on the go. Typical procedures to place lenses within the frame of a glass assembly include applying pressure to snap lenses in a groove of the frame. However, for smart glasses including an active, layered structure within the lenses, this methodology causes shear stress that may damage the layered structure causing the entire glass assembly to be discarded. It is also important to provide an impermeable electrical connection to the layered structure. In addition, it is desirable to simplify the lens mounting methodology so that prescription devices can be easily accommodated and replaced within a given glass assembly.

### SUMMARY

In a first embodiment, a device includes a frame, and an eyepiece. The eyepiece includes: a front glass, a rear glass, and an active element sandwiched between the front glass and the rear glass, and configured to be electrically activated, via an interconnect, by a flex circuit enclosed between a top portion of the frame and a cap, the flex circuit comprising a memory and a processor.

In a second embodiment, an augmented reality headset includes a frame including a flex circuit, a memory, and a processor. The augmented reality headset includes an eyepiece mounted on the frame, including an active element configured to modify an image transmitted through a front glass and a rear glass, and an interconnect configured to electrically couple the flex circuit with the active element.

A method for assembling a headset, includes placing a flex circuit inside a top portion of a frame for the headset, the flex circuit comprising a memory and a processor, placing an eyepiece on the frame for the headset, the eyepiece including an electrically active element having an interconnect, coupling the interconnect of the electrically active element in the eyepiece to the flex circuit in the frame, and placing a cap over the flex circuit and the interconnect.

### BRIEF DESCRIPTION OF THE DRAWINGS

FIG. 1 illustrates a smart glass, according to some embodiments.

FIGS. 2A-2B illustrate an assembly process for a smart glass and the forces involved therein, according to some embodiments.

FIGS. 3A-3C illustrate an assembly of components in a smart glass, according to some embodiments.

FIG. 4 illustrates an embodiment wherein the cap is placed after the eyepiece is fitted into the groove on the lower side of the frame, according to some embodiments.

FIG. 5 illustrates an embodiment where a reduced size active layer structure in the smart glass is placed between a front lens and a back lens, according to some embodiments.

FIGS. 6A-6B illustrate an over-mold seal applied on one point of retention in the lens-active layer structure compound, according to some embodiments.

FIGS. 7A-7D illustrate a frame including a perimeter gasket with compliant snap features to secure an eyepiece in a smart glass, and electronic interconnects, according to some embodiments.

FIGS. 8A-8B illustrate alignment features molded into the frame of a smart glass, according to some embodiments.

FIGS. 9A-9C illustrate a conductive rubber gasket to make contact with active elements in the eyepieces of a smart glass, according to some embodiments.

FIG. 10 is a flowchart illustrating steps in a method for assembling a smart glass, according to some embodiments.

In the figures, elements having the same or similar referral number have the same or similar features unless explicitly stated otherwise.

### DETAILED DESCRIPTION

In the field of wearable devices, electrical interconnects for smart glasses present a challenge due to the delicate parts involved and the stressful environmental conditions under which the devices are expected to operate seamlessly. For example, it is expected that electrical interconnects be compact, have a reduced weight, and be hermetic or impermeable to water, moisture, sweat, and other liquids. In addition, some of the electrically active circuits lay over or are adjacent to the eyepieces, which presents several challenges on its own. For example, mounting the eyepieces to the frame of the smart glass may require exertion of forces and stresses that can permanently damage the electrically active element. In addition, and assuming that an assembly process is devised to overcome the above challenge, there is the issue of having the ability to easily re-configure the smart glasses for a different user, or for a different optical prescription for the same user. If the assembly process is too complex and requires a series of steps in a specific sequence, these re-adjustments may create logistical problems for replacement components and storage/availability thereof. Accordingly, it is desirable to have smart glasses with simple, safe, and compact interconnects that have a seamless assembly process that allows reconfiguration of prescription glasses and part replacement without major factory rearrangements.

To resolve at least some of the above technical difficulties, several embodiments are proposed herein, as follows.

The present disclosure is related generally to a user interface for headsets and wearable devices. More specifically, the present disclosure is related to assembly and integration of electronic circuits in smart glasses for enhanced reality applications, according to some embodiments. Some embodiments include a flex circuit electrically coupled with active elements in the left and right eyepieces via an interconnect, on a top portion of the frame. In some embodiments, to protect the flex circuit, a cast-in-place gasket may be provided using a foaming material injected between the frame and a cap, before assembling the glasses, or after assembly, through a dedicated port. Some embodiments include a cap placed after the eyepiece is fitted into the groove on the lower side of the frame. This procedure reduces the forces exerted onto the eyepiece. Moreover, when a removable cap is used, the eyepiece may be replaced without substantive work, e.g., when a prescription component in the eyepiece needs adjustment or replacement. In some embodiments, a reduced size active layer structure in the smart glasses is placed between a front lens and a back lens. The active layer may include a liquid crystal sandwiched between two electrode layers, an oversized front glass, and an undersized rear glass. The front glass has a larger cross section that extends beyond the active layer structure and the rear glass. Accordingly, the front glass may be snapped into a groove in the frame, leaving the active layer structure untouched by the forces involved in the snapping/clamping mechanism. In some embodiments, the active layer may include additionally a prescription optics layer glued on top, also with reduced dimensions to avoid contact with the forces involved in the snapping/clamping mechanism. In yet other embodiments, an over-mold seal is applied on one point of retention in the lens-active layer structure compound. The over-mold seal snaps into a groove on the frame, and includes copper contacts that reach a flex circuitry within the frame of the smart glasses via a pin connector, so that the eyepiece is snuggly fit within the frame.

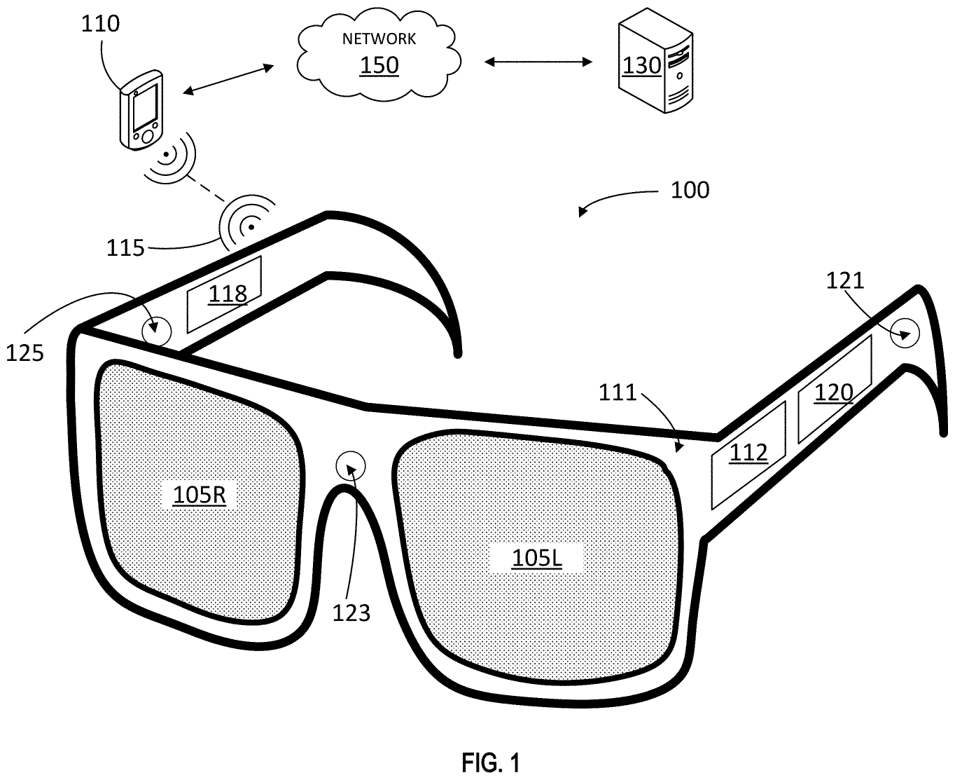

FIG. 1 illustrates a smart glass 100, according to some embodiments. Smart glass 100 includes a frame 111 holding left (105-L) and right (105-R) eyepieces (hereinafter, collectively referred to as “eyepieces 105”), a processor 112, a memory 120, and a communications module 118. Memory 120 stores instructions, which when executed by processor 112, cause smart glass 100 to perform at least some of the steps and operations disclosed herein. Communications module 118 generates electromagnetic (EM) signals 115 to communicate with a mobile device 110 (e.g., a mobile phone, palm or pad device for the user of the smart glasses). Mobile device 110 may in turn communicate with a remote server 130 via a network 150. Remote server 130 may host an application installed in mobile device 110, through which the user may control, adjust settings, provide, collect, and process data collected by smart glass 100. Accordingly, communications module 118 may include radio and antenna hardware and software, to provide and receive wireless signals from the mobile device and/or the remote server. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

In some embodiments, eyepieces 105 may include active elements such as liquid crystal layers configured to provide a variable tint or dimming of the glasses and other optical elements in eyepieces 105. Thus, the transparency of smart glass 100 may be adjusted either automatically or by user control according to environmental conditions, or user desire. To assess environmental conditions, smart glass 100 may include one or more sensors 125 configured as ambient light sensors, acoustic detectors, and the like, e.g., an inertial motion unit—IMU—such as an accelerometer or gyroscope. The ambient light sensors may be configured to detect visible light (VIS, 450 nm-750 nm), ultraviolet light (UV, 200 nm to 450 nm wavelength), infra-red light (IR, 750 nm to 10 μm wavelength), or any other desired wavelength range. For example, in some embodiments, a UV detector may indicate the presence of direct sunlight (e.g., the user is outdoors and/or in a bright sunny day). In addition, and as part of a user interaction system, smart glass 100 may include a speaker/microphone 121 so that the user may provide voice commands and receive audio feedback. In some embodiments, the user interface may include touch-sensitive controllers and cameras 123. All the above elements and components may be electrically coupled with one another via electrical circuit interconnects. The electrical circuit interconnects introduce considerations in the assembly and manufacturing of smart glass 100, as well as the materials used thereof, as disclosed herein.

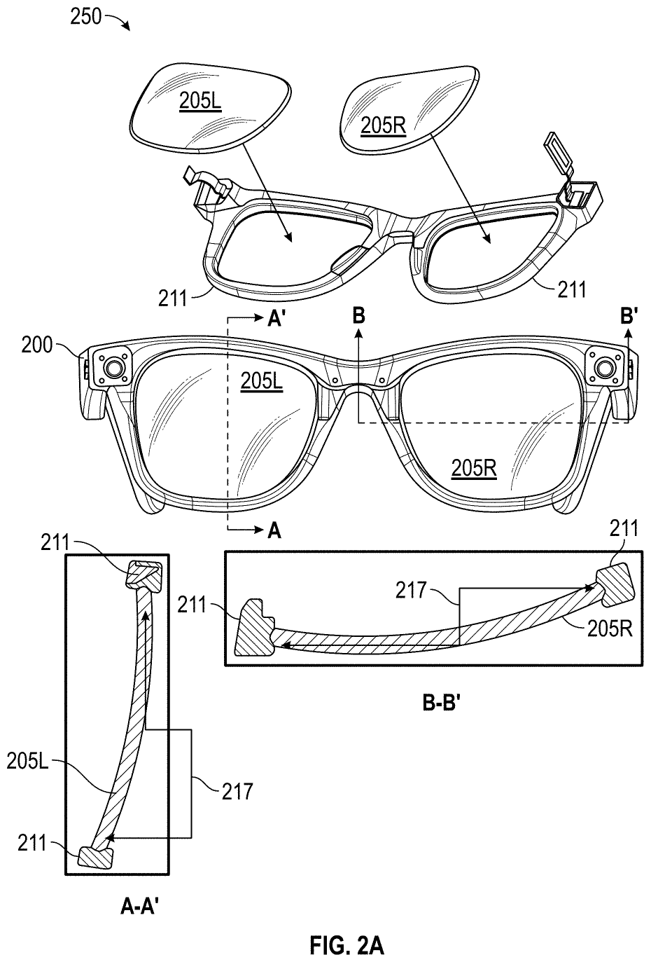

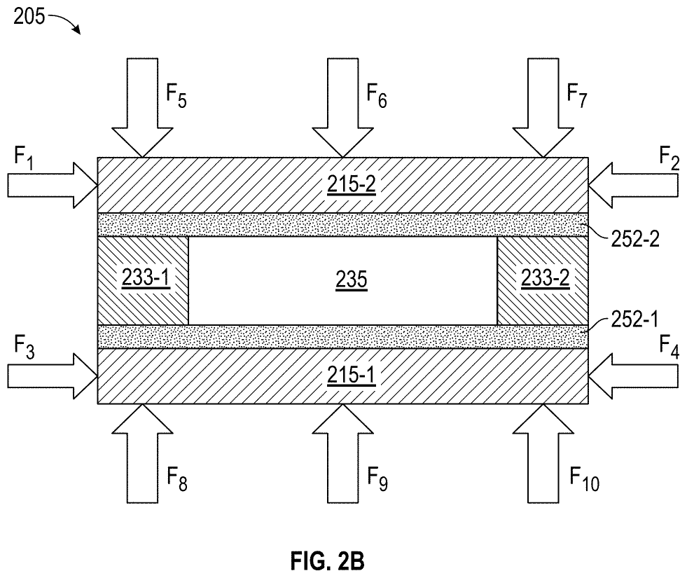

FIG. 2A illustrates an assembly process 250 for eyepieces 205L and 205R (hereinafter, collectively referred to as “eyepieces 205”) for a smart glass 200, according to some embodiments. In the figure, sections A-A′ and B-B′ illustrate undercut 217 in the circumference of a glass frame 210. Eyepieces 205 are thus press fit into undercut 217. In some circumstances, this press fitting may induce pressures and stresses on eyepieces 205, as follows.

FIG. 2B illustrates some of the forces F₁, F₂, F₃, F₄, F₅, F₆, F₇, F₈, F₉, and F₁₀ (hereinafter, collectively referred to as “forces F”), acting on the layered structure of an eyepiece 205 involved in assembly process 250, according to some embodiments. Eyepiece 205 is shown in cross sections, illustrating an active element 235 sandwiched between a front glass 215-1 and a rear glass 215-2 (hereinafter, collectively referred to as “glasses 215”). Glue portions 233-1 and 233-2 (hereinafter, collectively referred to as “glue portions 233”) create a space for active element 235 to separate a first electrode 252-1 from a second electrode 252-2 (hereinafter, collectively referred to as “electrodes 252”) and hold together the stack of eyepiece 205. Electrodes 252 provide power to turn active element 235 ‘on’ or ‘off,’ as desired.

In some embodiments, active element 235 may include a liquid crystal layer having a birefringent material with molecules configured to rotate according to an applied electric field (e.g., between electrodes 252). As the birefringent material rotates, a difference in polarization refraction may become susceptible to transmission changes through eyepiece 205, thus creating a desirable dimming or any other effect. In some embodiments, active element 235 and electrodes 252 are pixelated across the plane of eyepiece 205, so that an image may be superimposed (e.g., for an augmented reality application).

Each of forces F₁-F₄, independently, produce shear stress on glasses 215, potentially damaging glue portions 233. The combination of forces F₅, F₇, and F₉, or of forces F₈, F₁₀, and F₆ produces a bending of eyepiece 205, thus straining its cohesion and structural stability. The combination of forces F₅ and F₈, or F₇ and F₁₀, or of forces F₁ and F₂ or F₃ and F₄ produces compression. In some embodiments, compression effects may be acceptable, as their effect on the stability of the layered structure is less direct than for sheer stresses.

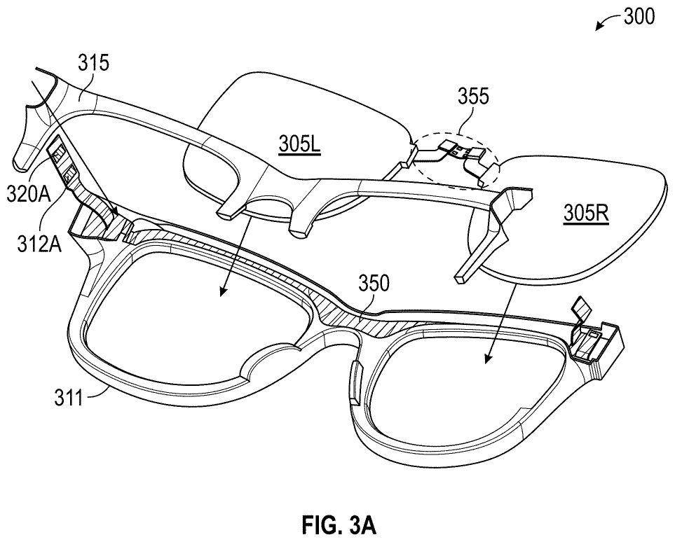

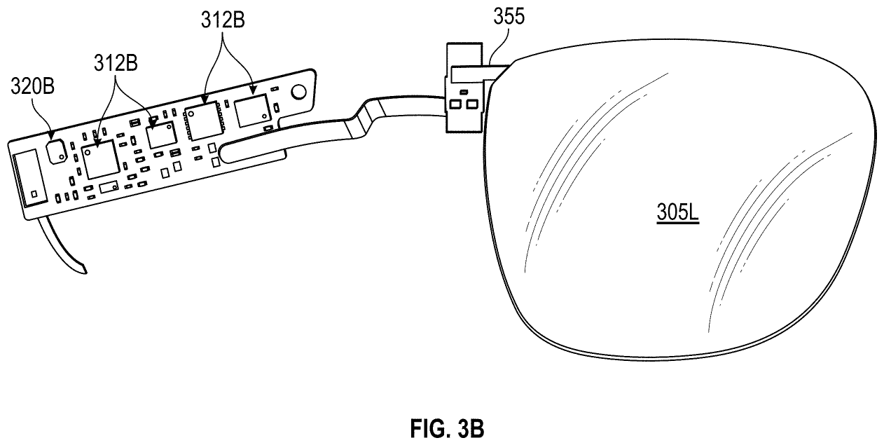

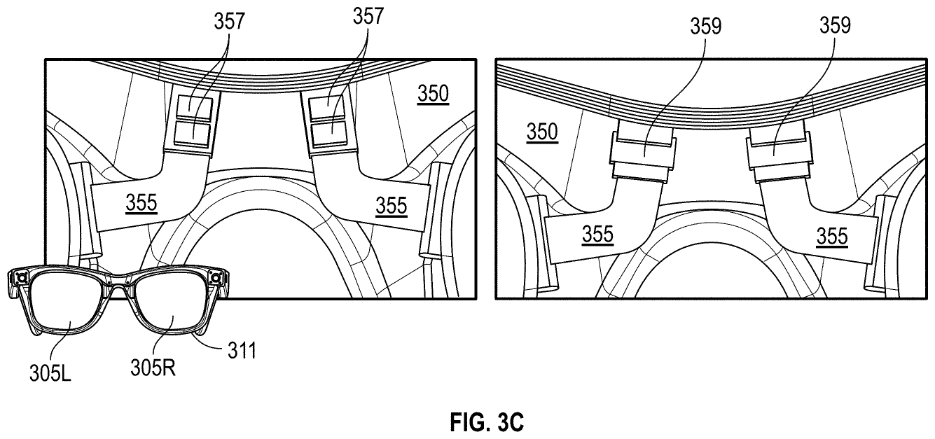

FIGS. 3A-3C illustrate an assembly of components in a smart glass 300, according to some embodiments. On a top portion or cap 315 of a frame 311, a flex circuit 350 is electrically coupled with active elements, e.g., a processor 312A and 312B (hereinafter, collectively referred to as “processors 312”), and a memory 320A and 320B (hereinafter, collectively referred to as “memories 320”) in the left and right eyepieces 305L and 305R (hereinafter, collectively referred to as “eyepieces 305”) via interconnects 355. Accordingly, memories 320 or processors 312 may provide instructions and control one or more active elements in eyepieces 305, sensors, microphones, cameras, and other devices (cf. microphone 121, controllers and cameras 123, and sensors 125). In some embodiments, to protect flex circuit 350, a cast-in-place gasket may be provided using a foaming material injected between frame 311 and cap 315, before or after assembling smart glass 300, through a dedicated port.

The foaming material, after cast, provides mechanical protection to flex circuit 350 and interconnects 355, and also serves as an absorber to remove humidity caused by sweat, water, and other liquids filtrating from the environment.

FIG. 3B illustrates an embodiment with processor 312B and memory 320B electrically coupled to eyepiece 305L via interconnects 355.

FIG. 3C illustrates an embodiment wherein smart glass 300 with eyepieces 305 includes interconnects 355 having contacts 357 electrically coupling interconnects 355 with flex circuit 350. Contacts 357 are insulated via caps 359 that may include an electrically isolating coating also configured to hermetically seal contacts 357.

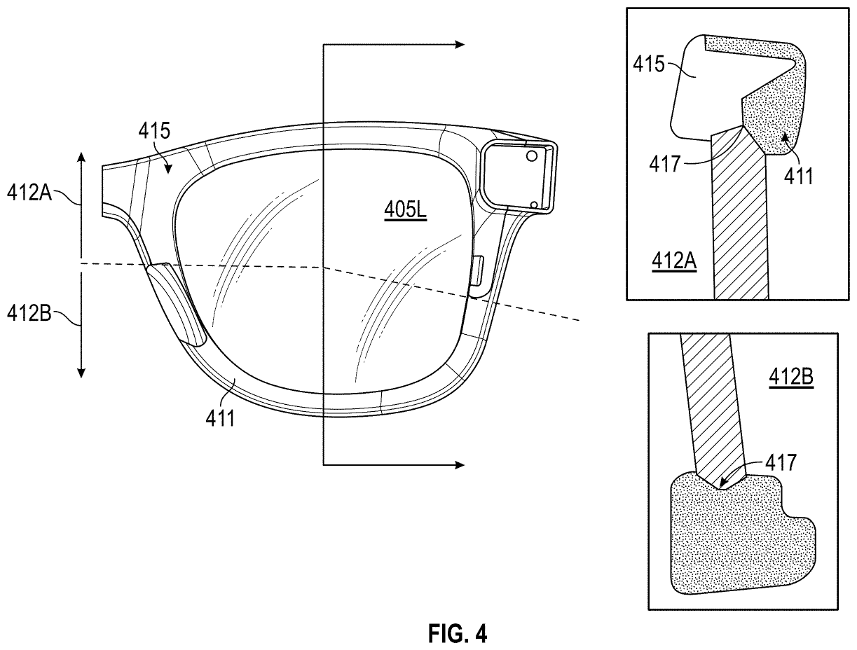

FIG. 4 illustrates an embodiment wherein a cap 415 is placed after eyepiece 405L is fitted into a groove 417 on an upper side 412A and a lower side 412B of a frame 411, according to some embodiments. Cap 415 forms groove 417 in the upper side 412A of frame 411, thus securing eyepiece 405L in place. By this procedure, forces involved in the assembly of a smart glass (cf. “forces F,” FIG. 2B), exerted onto eyepiece 405L, are substantially suppressed. Moreover, when a removable cap 415 is used, eyepiece 405L may be replaced without substantive work, e.g., when a prescription component in eyepiece 405L needs adjustment or replacement.

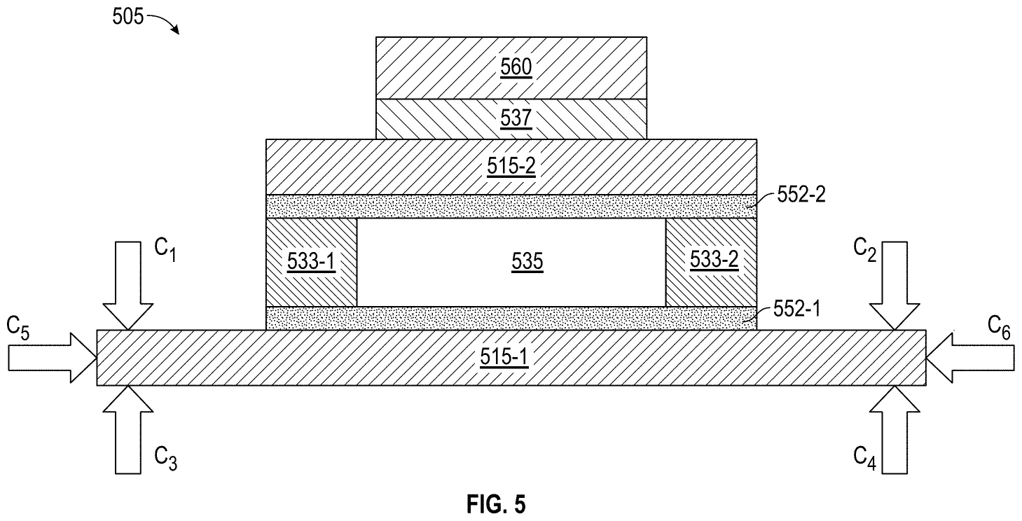

FIG. 5 illustrates an embodiment where a reduced size active element 535 in an eyepiece 505 is placed between a front glass 515-1 and a rear glass 515-2 (hereinafter, collectively referred to as “glasses 515”). Active element 535 may include a liquid crystal sandwiched between two electrode layers 552-1 and 552-2 (hereinafter, collectively referred to as “electrodes 552”), and glasses 515. Glue layers 533-1 and 533-2 (hereinafter, collectively referred to as “glue layers 533”) provide a space for active element 535 and hold together the stack on top of front glass 515-1. Front glass 515-1 has a larger cross section and extends beyond active element 535 and rear glass 515-2. Accordingly, front glass 515-1 may be snapped into a groove in the frame via the normal procedure (cf. grooves 217 and 417), with minimal impact on active element 535 by the forces C₁, C₂, C₃, C₄, C₅, and C₆ (hereinafter, collectively referred to as “forces C”) involved in the snapping/clamping mechanism (cf. forces F, FIG. 2B). In some embodiments, active element 535 may include additionally a prescription optics layer 560 placed on top (via a glue layer 537), also with reduced dimensions to avoid contact with forces C, during assembly.

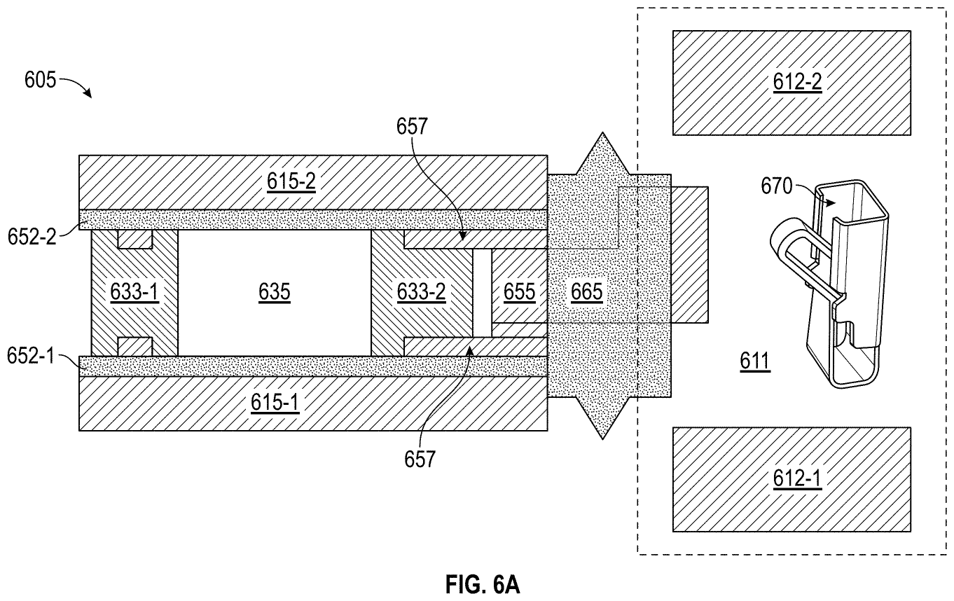

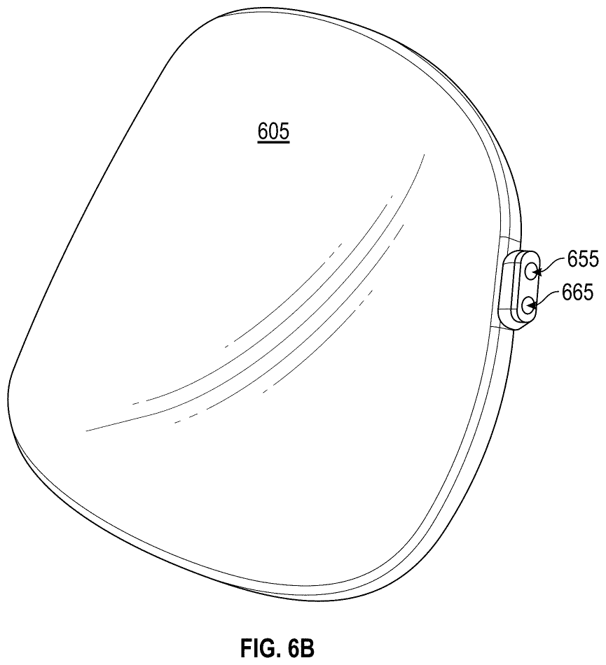

FIGS. 6A-6B illustrate an over-mold seal 665 applied on one point of retention in an eyepiece 605, according to some embodiments. The layered structure of eyepiece 605 includes front and rear glasses 615-1 and 615-2 (hereinafter, collectively referred to as “glasses 615”), and electrodes 652-1 and 652-2 (hereinafter, collectively referred to as “electrodes 652”) providing electrical signals to an active element 635. Glue layers 633-1 and 633-2 (collectively referred to, hereinafter, as “glue layers 633”) provide a spacer for active layer 635 and structural support to the stack, including contacts 657.

Over-mold seal 665 snaps into a groove on a front side 612-1 and a rear side 612-2 of a frame 611. An interconnect 655 (e.g., copper) reaches a flex circuit within a frame 611 of the smart glasses via a pin connector 670. In some embodiments, instead of a pin connector 670, interconnect 655 may include a spring loaded pogo pin. Eyepiece is snuggly fit within frame 611 while interconnect 655 is securely placed in contact with the flex circuit via over-mold seal 665.

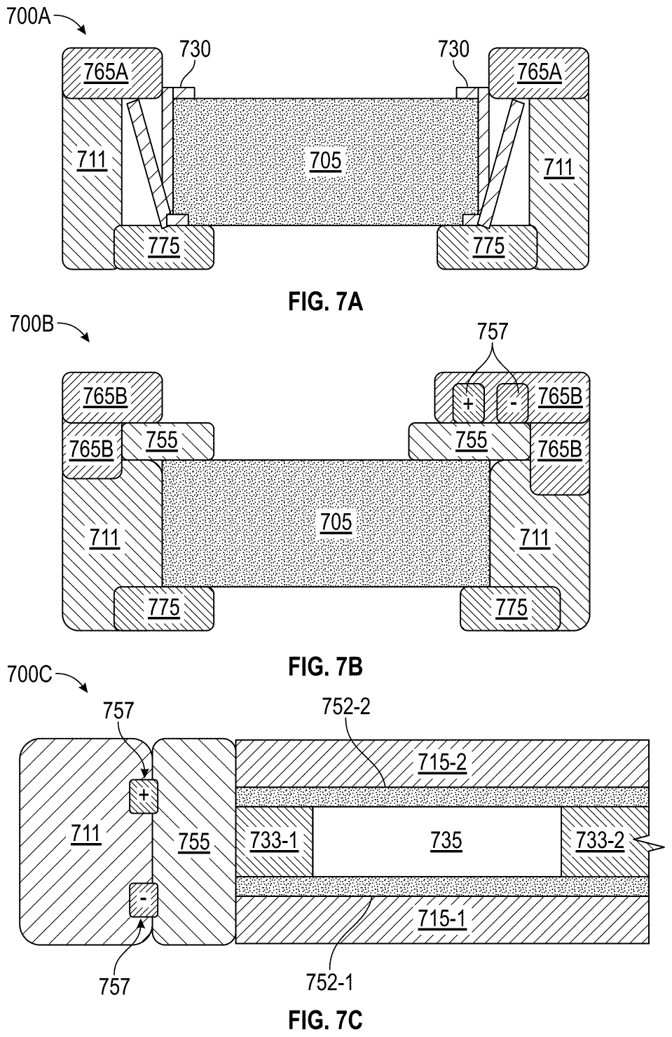

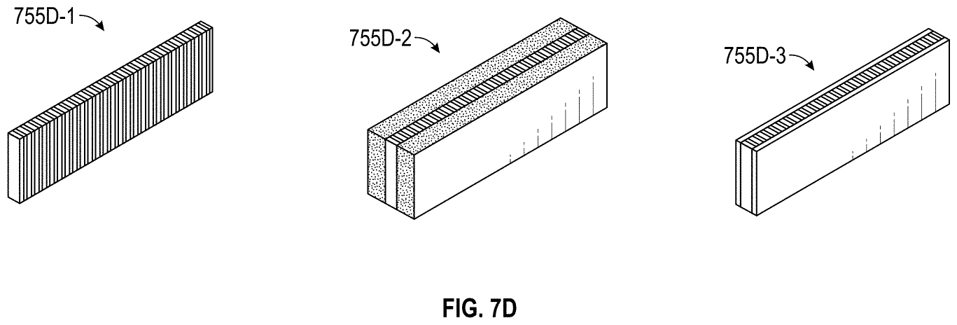

FIGS. 7A-7D illustrate a frame 711 including perimeter gasket 765A and 765B (hereinafter, collectively referred to as “perimeter gaskets 765”) with compliant snap features 730 to secure an eyepiece 705 in a smart glass, and electronic interconnects 755, 755D-1, 755D-2, and 755D-3 (hereinafter, collectively referred to as “interconnects 755”), according to some embodiments. An active element 735 is placed between a front glass 715-1 and a rear glass 715-2 (hereinafter, collectively referred to as “glasses 715”). Active element 735 may include a liquid crystal sandwiched between two electrode layers 752-1 and 752-2 (hereinafter, collectively referred to as “electrodes 752”), and glasses 715. Glue layers 733-1 and 733-2 (hereinafter, collectively referred to as “glue layers 733”) provide a space for active element 735 and hold together the stack on top of front glasses 715.

FIG. 7A illustrates snap feature 730 in a smart glass 700A, which may be a metal or plastic spring that is inserted into frame 711, together with eyepiece 705. When there is a need to remove or replace eyepiece 705, snap feature 730 can be dislodged easily, relieving eyepiece 705 from frame 711. A clamp feature 775 holds the front of eyepiece 705, against snap feature 730.

FIG. 7B is a partial cross section of a smart glass 700B, illustrating one of eyepieces 705. Clamp feature 775 holds the front of eyepiece 705, against interconnect 755. Clamp feature 775 may be a metal or plastic piece formed into a C shape that can be press-fit into frame 711. The tension in clamp feature 775 keeps it in place, securely stopping eyepiece 705 in the forward direction. Eyepiece 705 is stopped in the rear direction by interconnect 755. In some embodiments, a lip may protrude out of the rear of eyepiece 705 (e.g., a stepped lens, and the like), thus securing it to frame 711. Smart glass 700B also includes connectors 757 (one positive, one negative, without loss of generality).

FIG. 7C is a partial cross section of a smart glass 700C illustrating interconnect 755 coupled to connectors 757 on the side of frame 711, and to electrodes 752-1 and 752-2 (hereinafter, collectively referred to as “electrodes 752”).

FIG. 7D illustrates different types of connectors 755D-1, 755D-2, and 755D-3 that can be used in embodiments as disclosed herein. Connector 755D-1 may be a carbon liquid crystal display connector with no insulation. Connector 755D-2 may be a carbon liquid crystal display connector with foam padding or solid silicone as insulator. And connector 755D-3 may be a carbon liquid crystal display connector sandwiched between two insulating layers.

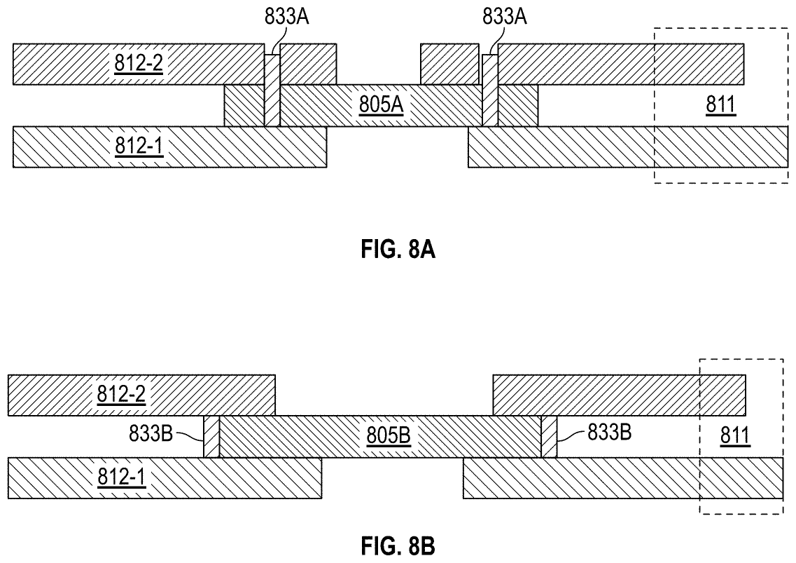

FIGS. 8A-8B illustrate alignment features 833A and 833B (hereinafter, collectively referred to as “alignment features 833”) molded into the frame of a smart glass, according to some embodiments. Alignment features 833 center eyepieces 805A and 805B (hereinafter, collectively referred to as “eyepieces 805”) between a front side 812-1 and a rear side 812-2 of a frame 811 for a smart glass. In some embodiments, a gap between front side 812-1 and rear side 812-2 may be occupied with electrical interconnects and circuitry to feed power and data to an active element within eyepieces 805.

FIG. 8A illustrates an embodiment wherein alignment features 833A go through eyepiece 805A.

FIG. 8B illustrates an embodiment wherein alignment features 833B are adjacent to the sides of eyepiece 805B.

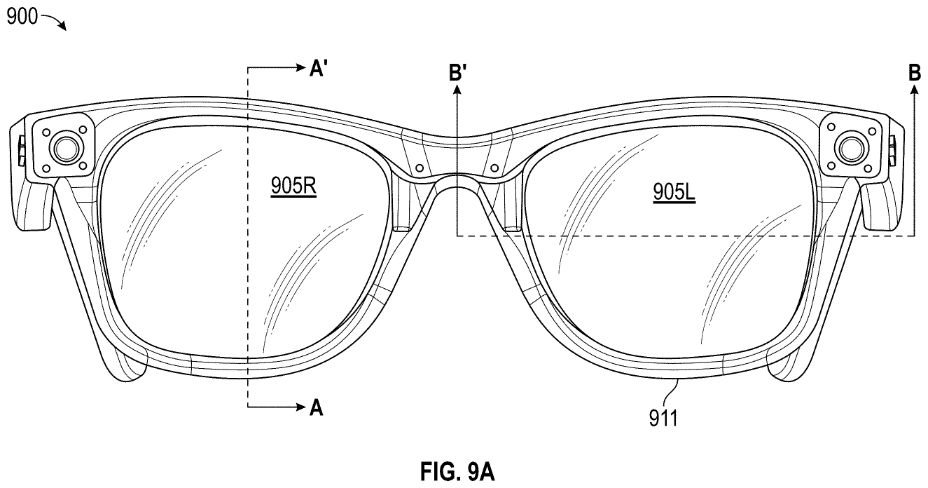

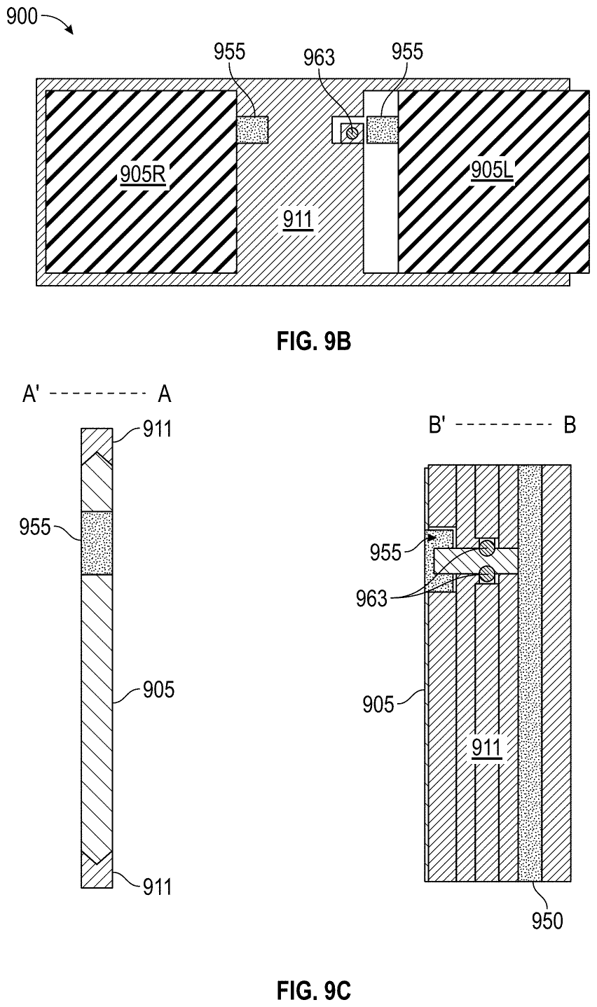

FIGS. 9A-9C illustrate a conductive rubber gasket 963 to make contact with active elements in eyepieces 905R and 905L (hereinafter, collectively referred to as “eyepieces 905”) of a smart glass, according to some embodiments. A frame 911 contains a flex circuit 950, and interconnects 955 electrically couple an active element in eyepieces 905 with flex circuit 950.

FIG. 9A is a plan view of smart glass 900 illustrating frame 911 and eyepieces 905. A section A′-A and a section B′-B are also illustrated.

FIG. 9B is a block diagram of smart glass 900, illustrating the relative positioning of rubber gasket 963, interconnects 955, and eyepieces 905. A second rubber gasket 963 is blocked in view by interconnect 955 in eyepiece 905R.

FIG. 9C is a block diagram of sections A′-A and B′-B in FIG. 9A. Note that in section B′-B the eyepiece 905 is barely visible as it is snuggly fit behind frame 911. Flex circuit 950 is clearly shown in this view.

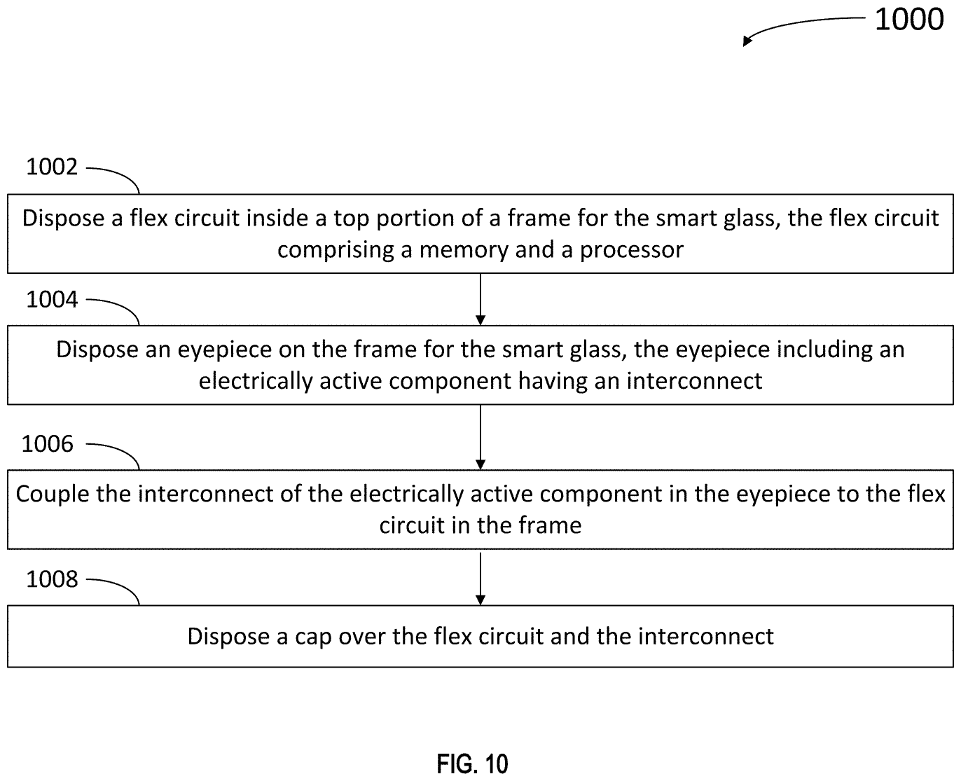

FIG. 10 is a flowchart illustrating steps in a method 1000 for assembling a smart glass, according to some embodiments. The smart glass may include a frame, a left and a right eyepiece, a memory, a processor, a communications module, and a cap, as disclosed herein (cf. FIG. 1). Methods consistent with method 1000 may include at least one of the steps in method 1000 performed in a different order, simultaneously, quasi-simultaneously, or overlapping in time.

Step 1002 includes disposing a flex circuit inside a top portion of a frame for the smart glass, the flex circuit including a memory and a processor.

Step 1004 includes disposing an eyepiece on the frame for the smart glass, the eyepiece including an electrically active element having an interconnect. In some embodiments, step 1004 includes clamping a front glass in the eyepiece and snapping the front glass in a groove of the frame with a clamping device. In some embodiments, step 1004 includes over-molding, over the interconnect, an electrically insulating material, fixing the electrically insulating material to a groove in the frame, and snuggly fitting the eyepiece within the frame.

Step 1006 includes coupling the interconnect of the electrically active element in the eyepiece to the flex circuit in the frame.

Step 1008 includes disposing a cap over the flex circuit and the interconnect. In some embodiments, step 1008 includes filling a space between the flex circuit and the interconnect with a moisture absorbing material that is also electrically insulating.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A device, comprising:
a frame; and
an eyepiece, wherein the eyepiece includes:
a front glass,
a rear glass, and
an active element sandwiched between the front glass and the rear glass, and configured to be electrically activated, via an interconnect, by a flex circuit enclosed between a top portion of the frame and a cap, the flex circuit comprising a memory and a processor.

2. The device of claim 1, wherein the front glass has a larger cross section than a cross section of the rear glass and the active element, to allow a clamping device to press the eyepiece into a groove formed in the frame, during assembly.

3. The device of claim 1, further comprising a prescription optical layer adjacent to the rear glass, the prescription optical layer having a cross section no larger than a cross section of the rear glass.

4. The device of claim 1, further comprising a cast-in-place gasket including a foaming material filling a space between the frame and the cap.

5. The device of claim 1, wherein the interconnect comprises an insulating material over-molded onto the rear glass and the front glass to fit a groove formed in the frame, and at least one conducting prong to make electrical contact with a pin connector inserted in the frame and electrically coupled with the flex circuit, wherein the front glass and the rear glass have a shape to snugly fit within the frame.

6. The device of claim 1, wherein the interconnect includes a conductive rubber gasket for electrically coupling an active element in the eyepiece and the flex circuit, and for mechanically securing the interconnect to the frame.

7. The device of claim 1, wherein the interconnect includes a conductive adhesive or a conductive ink reaching different terminals in the active element.

8. The device of claim 1, further comprising a perimeter gasket to mount the eyepiece on the frame, and a compliant snap feature for mechanically coupling the eyepiece to the perimeter gasket.

9. The device of claim 1, further comprising a clip that snap fits onto a front portion of the frame to securely hold the eyepiece against a resilient stop on a back portion of the frame.

10. The device of claim 1, further comprising an alignment feature molded on the frame to align an active element the eyepiece with the interconnect.

11. An augmented reality headset, comprising:
a frame including a flex circuit, a memory, and a processor;
an eyepiece mounted on the frame, including an active element configured to modify an image transmitted through a front glass and a rear glass; and
an interconnect configured to electrically couple the flex circuit with the active element.

12. The augmented reality headset of claim 11, wherein the active element is sandwiched between a front glass and a rear glass, the front glass configured to mechanically couple the eyepiece to the frame.

13. The augmented reality headset of claim 11, wherein the eyepiece comprises a removable prescription optical layer.

14. The augmented reality headset of claim 11, further comprising a cast-in-place gasket including a foaming material securing the flex circuit, the memory and the processor inside the frame.

15. A method for assembling a headset, comprising:
placing a flex circuit inside a top portion of a frame for the headset, the flex circuit comprising a memory and a processor;
placing an eyepiece on the frame for the headset, the eyepiece including an electrically active element having an interconnect;
coupling the interconnect of the electrically active element in the eyepiece to the flex circuit in the frame; and
placing a cap over the flex circuit and the interconnect.

16. The method of claim 15, wherein placing an eyepiece on the frame of the headset comprises clamping a front glass in the eyepiece and snapping the front glass in a groove of the frame with a clamping device.

17. The method of claim 15, wherein placing an eyepiece on the frame of the headset comprises:
over-molding, on the interconnect, an electrically insulating material;
fixing the electrically insulating material to a groove in the frame; and
snuggly fitting the eyepiece within the frame.

18. The method of claim 15, wherein placing a cap over the flex circuit and the interconnect comprises filling a space between the flex circuit and the interconnect with a moisture absorbing material that is also electrically insulating.

19. The method of claim 15, wherein placing an eyepiece on the frame for the headset, comprises snap-fitting a clip onto a front portion of the frame to securely hold the eyepiece against a resilient stop on a back portion of the frame.

20. The method of claim 15, wherein placing an eyepiece on the frame for the headset comprises mechanically coupling the eyepiece to a perimeter gasket with a compliant snap feature.
